(19) United States
(12) Patent Application Publication
(10) Pub. No.: US 2018/0314912 A1
(43) Pub. Date: Nov. 1, 2018

(54) IDENTIFICATION OF IMAGES

(71) Applicant: ENT. SERVICES DEVELOPMENT CORPORATION LP, Houston, TX (US)

(72) Inventor: Joseph MILLER, Boulder, CO (US)

(73) Assignee: ENT. SERVICES DEVELOPMENT CORPORATION LP, Houston, TX (US)

(21) Appl. No.: 15/771,074

(22) PCT Filed: Oct. 28, 2015
(86) PCT No.: PCT/US2015/057755

§ 371 Date: Apr. 25, 2018

(51) Int. Cl. G06K 9/62; G06K 9/46; G06K 9/38

(52) U.S. Cl. CPC G06K 9/6212; G06K 2209/25; G06K 9/38; G06K 9/4647

(57) ABSTRACT

In example implementations, an image is identified. The image may be received. A radial histogram of each layer of the image is generated. The radial histogram of each layer of the image may be compared to at least one of a plurality of pre-generated radial histograms of a respective layer of a plurality of layers of a known image, wherein the plurality of layers is compressed into a consolidated set of bytes and the comparing is performed in parallel via the consolidate set of bytes. The image may be identified as a match of the known image when a match percentage of the radial histogram of the each layer of the image compared to the at least one of the plurality of pre-generated radial histograms of the respective layer of the plurality of layers of the known image is above a match threshold.

### BACKGROUND

Logo detection and matching can be used for a variety of different applications. Logo detection can include multiple steps. One step is related to how the logo is represented for automated detection and matching. For example, the logo can be represented as a variety of different shapes and colors in a variety of different regions within an area that is being analyzed. This can be represented as a complex set of bits that may involve a large amount of comparisons and processing.

### BRIEF DESCRIPTION OF THE DRAWINGS

FIG. 1 is a block diagram of an example system of the present disclosure;

FIG. 2 is a block diagram an example server of the present disclosure;

FIG. 3 is an example diagram that illustrates a method for compressing monochromatic images;

FIG. 4 is an example diagram of a radial histogram construct;

FIG. 5 is an example diagram of performing multilayer pattern matching;

FIG. 6 is a flow diagram of an example method for identifying an image as a known image; and

FIG. 7 is another example block diagram of the server.

### DETAILED DESCRIPTION

The present disclosure relates to techniques for identifying images. As discussed above, logo detection can include multiple steps. One step is related to how the logo is represented for automated detection and matching. For example, the logo can be represented as a variety of different shapes and colors in a variety of different regions within an area that is being analyzed. This can be represented as a complex set of bits that uses a large amount of comparisons and processing if each set of bits is processed in a serial manner.

Examples of the present disclosure identify an image by performing multilayer pattern matching. For example, the present disclosure may scan for and match a plurality of different layers of an image in parallel, or substantially simultaneously, when analyzing bytes within a two-dimensional byte array window.

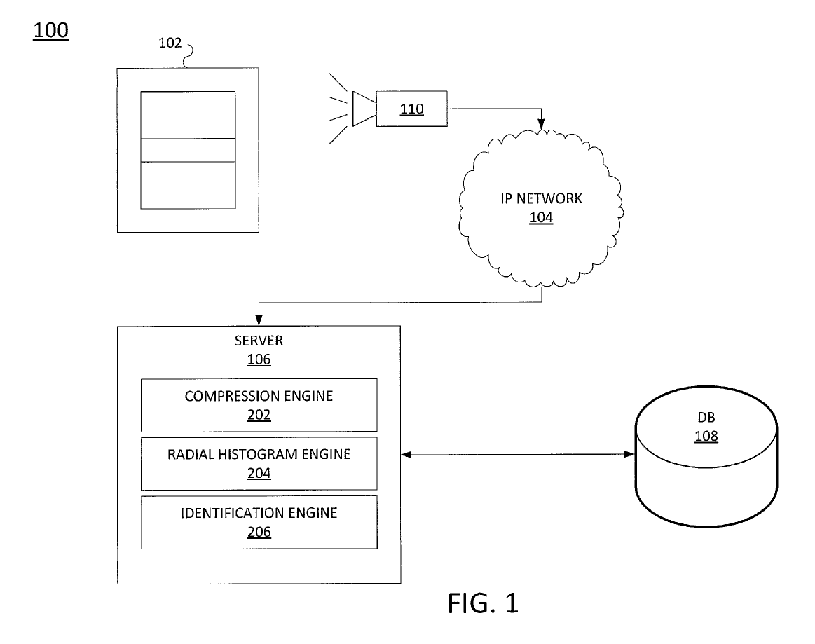

FIG. 1 illustrates an example system 100 of the present disclosure. The system 100 includes a server 106, a database (DB) 108 and an image capture device 110. In one example, the image capture device 110 may be any type of red, green, blue (RGB) video camera, photographic camera, and the like.

In one implementation, the image capture device 110 may be locally connected to the server 106 or may be remotely connected to the server 106 over an Internet Protocol (IP) network 104. The IP network 104 may include additional network elements, such as, gateways, routers, switches, access networks, and the like, not shown.

In one implementation, the image capture device 110 may capture an image 102. In one example, the image 102 may be a logo. The image 102 may be transmitted to the server 106 for identification. In other implementations, the image 102 may be processed by the image capture device 110.

The image 102 may be comprised of pixels. For ease of explanation, the examples described herein may assume that each pixel comprises a single byte of eight bits, e.g., the eight bits are used to store information pertaining to each pixel. Thus, the image 102 may be comprised of a plurality of pixels or a plurality of bytes (although differently sized units of data other than bytes may be used). In one example, the information of each pixel (e.g., visible color, hyperspectral data, etc.) may be determined from the bits of the byte.

In one example, the DB 108 may store various information and data. For example, the DB 108 may store pre-generated monochromatic images (also referred to herein as “known monochromatic images”) of each layer of a known image, radial histograms of the pre-generated monochromatic images, thresholds used to create each pre-generated monochromatic image, and the like. Although a single DB 108 is illustrated in FIG. 1, it should be noted that any number of databases may be deployed.

In one example, the server 106 may include an apparatus 200 that includes a compression engine 202, a radial histogram engine 204 and an identification engine 206. The compression engine 202, the radial histogram engine 204 and the identification engine 206 may perform the functions described herein to identify images. In other implementations, the apparatus 200 may be deployed in the image capture device 110.

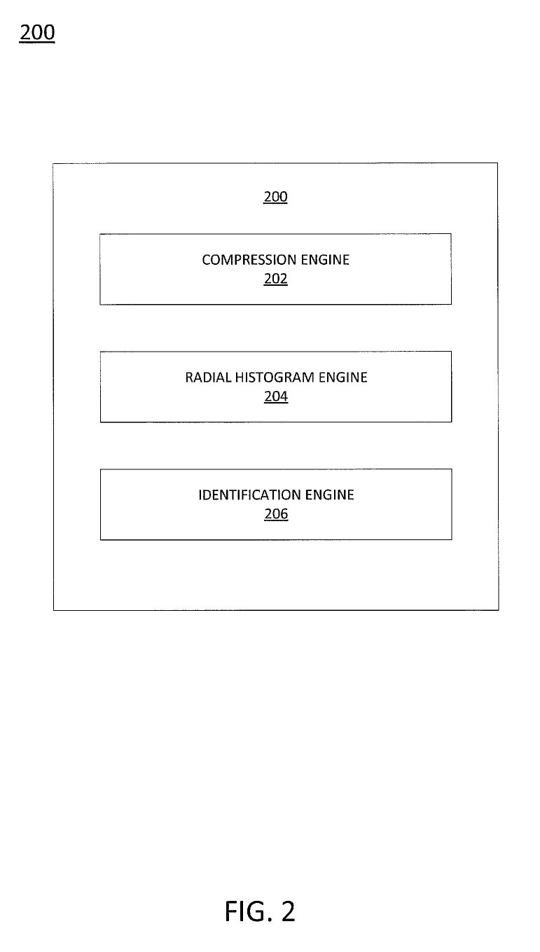

FIG. 2 illustrates a block diagram of an example apparatus 200 of the present disclosure. The apparatus 200 may be implemented as a computing device that includes the compression engine 202, the radial histogram engine 204 and the identification engine 206, which may be any combination of hardware and programming to implement the functionalities of the engines described herein. In examples, described herein, such combinations of hardware and programming may be implemented in a number of different ways. For example, the programming for the engines may comprise processor executable instructions stored on at least one non-transitory machine-readable storage medium and the hardware for the engines may include at least one processing resource (e.g., a graphical processing unit (GPU) or a central processing unit (CPU)) to execute those instructions. In some examples, the hardware may include other electronic circuitry to at least partially implement at least one engine of the apparatus 200.

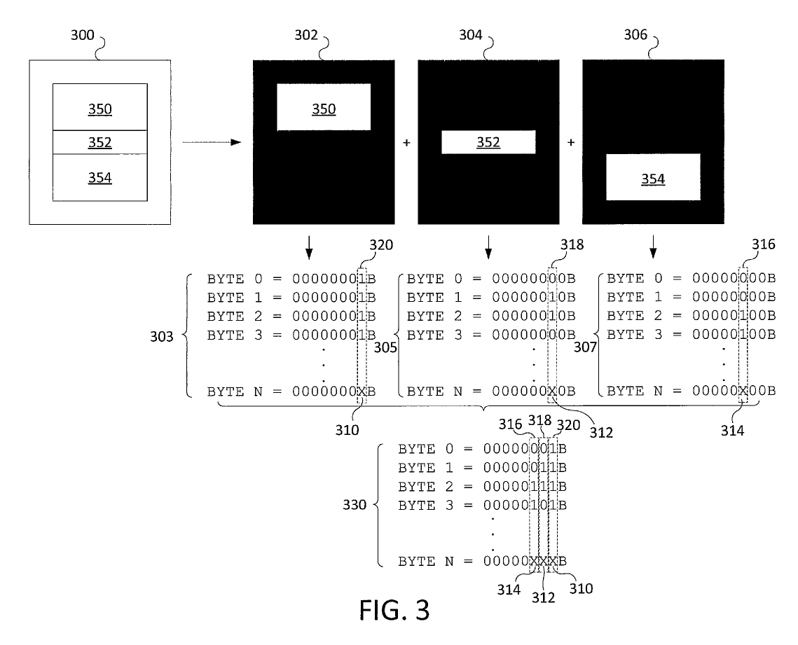

In one example, the compression engine 202 may compress image data into a consolidated set of bytes. The consolidated set of bytes may contain image information used to create radial histograms of a known image. The radial histograms can be used to identify a subsequently received image. The consolidated set of bytes allows each layer of the subsequently received image to be identified in parallel, as discussed below. FIG. 3 provides an example diagram that illustrates a method for compressing image data to create a consolidated set of bytes 330.

In FIG. 3, a known image 300 may include layers 350, 352 and 354, each of which may correspond to different features in the known image 300. For example, the layers 350, 352 and 354 may each correspond to differently colored features (e.g., the layer 350 may be a blue colored rectangle at the top of the known image 300, the layer 352 may be a red colored rectangle in the middle of the known image 300, etc.). The known image 300 may be a logo, for example.

The known image 300 may be separated into three known monochromatic images 302, 304 and 306. The three known monochromatic images 302, 304 and 306 may also be comprised of a plurality of bytes (e.g., 1 to N bytes). For example, the known monochromatic image 302 may be represented by a plurality of N bytes 303, the known monochromatic image 304 may be represented by a plurality of N bytes 305 and the known monochromatic image 306 may be represented by a plurality of N bytes 307. Each one of the known monochromatic images 302, 304 and 306 may represent a different layer 350, 352 and 354 of the known image 300.

Each one of the known monochromatic images 302, 304 and 306 may be created by applying a thresholding process to the known image 300. For example, each layer 350, 352 and 354 of the known image may be associated with a respective threshold value. For example, a threshold 1 may be applied to the known image 300 to create the known monochromatic image 302, a threshold 2 may be applied to known image 300 to create the known monochromatic image 304, and a threshold 3 may be applied to the known image 300 to create the known monochromatic image 306.

In some implementations, the threshold may be a range of values. The threshold used to create each respective monochromatic image 302, 304 and 306 from the known image 300 may be based on a color of the respective layer. For example, the top rectangle in the layer 350 may be a blue color, as described above. As a result, a threshold having a value or a range of values near a blue color may be selected to generate the known monochromatic image 302. The middle rectangle in the layer 352 may be a red color, as described above. As a result, a threshold having a value or a range of values near a red color may be selected to generate the known monochromatic image 304. The bottom rectangle in the layer 354 may be a white color. As a result, a threshold having a value or a range of values near a white color may be selected to generate the known monochromatic image 306.

Thus, by using the thresholding process, a full color image that includes N pixels (where, e.g., N pixels are represented by N respective bytes, and the color of each pixel is determined by all 8 bits of the corresponding byte) may be separated into a plurality of monochromatic images (e.g., the known monochromatic images 302, 304 and 306), where each of the monochromatic images represents a respective layer of the color image. Each monochromatic image may be black and white, that is, each pixel of a monochromatic image may be represented by a single bit value of 0 or 1 in a byte, in comparison to an 8-bit color value of the full color image. More particularly, because a pixel value of a monochromatic image is a single bit in size, the pixel values of the monochromatic image may be stored at the same single bit offset across the N bytes. The single bit pixel values of different monochromatic images may be stored respectively at different single bit offsets across the N bytes. Thus, a column of bit values taken from a particular bit offset across the plurality of N bytes may represent a particular monochromatic image.

For example, in FIG. 3, the monochromatic image 302 may be represented by a column of bit values 320 at a single bit offset 310 of the plurality of N bytes 303. The monochromatic image 304 may be represented by a column of bit values 318 at a single bit offset 312 of the plurality of N bytes 305. The monochromatic image 306 may be represented by a column of bit values 316 at a single bit offset 314 of the plurality of N bytes 307.

The column of bit values 320, 318 and 316 at the single bit offsets 310, 312 and 314, respectively, can be combined to form the consolidated set of N bytes 330. The consolidated set of N bytes 330 may be a new plurality of N bytes that are used to store the columns of bit values 320, 318 and 316 at the single bit offsets 310, 312 and 314, respectively. For example, the plurality of N bytes 303, 305 and 307 may be combined using a set union or a logical OR operation to create the consolidated set of N bytes 330. Thus, the plurality of layers 350, 352 and 354 can be compressed into the consolidated set of N bytes 330 that allows for parallel processing when trying to identify an image, as discussed below.

It should be noted that although three different layers are illustrated in FIG. 3, up to 8 different layers may be compressed into a single byte that comprises 8 bits. In other examples, more than 8 layers may be compressed into bits of multiple bytes.

Also, it should be noted that although three known monochromatic images 302, 304 and 306 from the same known image 300 are illustrated as being compressed into the consolidated set of N bytes 330, that a column of bit values in a single bit offset of the consolidated set of N bytes 330 may include different monochromatic images from different known images. In other words, a consolidated set of N bytes 330 may include a column of bit values in different single bit offsets that represent monochromatic images from different known images.

Referring back to FIG. 2, the radial histogram engine 204 may create a radial histogram for a known monochromatic image. In some implementations, the radial histogram engine 204 creates a radial histogram for each known monochromatic image 302, 304 and 306. For example, the radial histogram for the known monochromatic image 302 may be based on the column of bit values 320 in the single bit offset 310 in the consolidated set of N bytes 330. Similarly, the radial histogram for the known monochromatic image 304 may be based on the column of bit values 318 in the single bit offset 312 of the consolidated set of N bytes 330. The radial histogram for the known monochromatic image 306 may be based on the column of bits 316 in the single bit offset 314 of the consolidated set of N bytes 330.

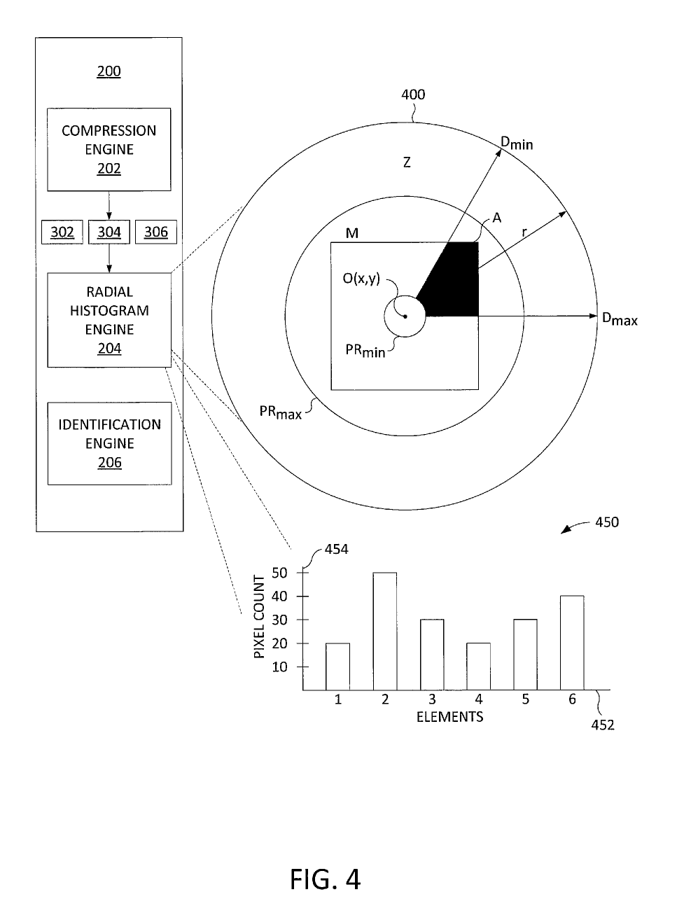

In one example, the radial histogram may be created from each known monochromatic image 302, 304 and 306 using a radial histogram construct 400 described below in FIG. 4. The radial histogram of each known monochromatic image 302, 304 and 306 may represent a respective bit pattern in the N bytes 303, 305 and 307. For example, the bit pattern in the column of bit values 320 of the single bit offset 310 may be represented by the radial histogram that is created for the known monochromatic image 302, and so forth.

FIG. 4 illustrates an example radial histogram construct 400 that can be generated by the radial histogram engine 204. The radial histogram construct 400 can be overlaid on the known monochromatic images 302, 304 and 306 that are input into the radial histogram engine 204 from the compression engine 202 to create the respective radial histograms.

In one example, the radial histogram construct 400 may be based at an origin O. The origin may be based on an (x, y) coordinate pair of the two-dimensional byte array of the known image 300. The radial histogram construct 400 may have a radius r and cover an area Z within the radial histogram construct 400.

The radial histogram construct 400 may be placed over a set of pixels or plane M (e.g., the N bytes 303, 305 and 307 in the known monochromatic images 302, 304 and 306, respectively). The total area that is processed may be based on a processing ring minimum (PRₘᵢₙ) and processing ring maximum (PRₘₐₓ) where 0<PRₘᵢₙ<PRₘₐₓ in some examples. The pixels within the boundaries of PRₘᵢₙ and PRₘₐₓ, including on the arc, may be included for processing. The variables PRₘᵢₙ and PRₘₐₓ may be considered as the distance along the radius r that is included for processing.

The radial histogram construct 400 may also include variables such as degree minimum (Dₘᵢₙ) and degree maximum (Dₘₐₓ). Dₘᵢₙ and Dₘₐₓ may represent a start degree and a stop degree within the radial histogram construct 400, The range of Dₘᵢₙ and Dₘₐₓ may be 0 to 360 degrees (in whole number increments or fractional increments), therefore 0<=Dₘᵢₙ<=Dₘₐₓ in some examples. The increment from Dₘᵢₙ to Dₘₐₓ may be referred to as the “resolution” of the radial histogram.

The combination of variables PRₘᵢₙ, PRₘₐₓ, Dₘᵢₙ and Dₘₐₓ may provide an area A (shaded in FIG. 4) of plane M that is within the bounds of PRₘᵢₙ, PRₘₐₓ, Dₘᵢₙ and Dₘₐₓ selected for processing. Said another way, the area of M that intersects PRₘᵢₙ, PRₘₐₓ, Dₘᵢₙ and Dₘₐₓ is the area A of pixels selected to be processed by the radial histogram construct 400.

The radial histogram construct 400 may be used to analyze the area A of M that intersects PRₘᵢₙ, PRₘₐₓ, Dₘᵢₙ and Dₘₐₓ to determine if a pixel within the area A is on or off (e.g., whether the pixel has a value of 0 or 1, is black or white, is light or dark, and the like). The variables PRₘᵢₙ, PRₘₐₓ, Dₘᵢₙ and Dₘₐₓ may be changed to cover a predefined number of different elements. For example, the radial histogram construct 400 may be divided into six non-overlapping radial slices or zones that each serve as an element. The area A illustrated in FIG. 4 may be an element.

FIG. 4 illustrates an example of a radial histogram 450 that can be created by applying the radial histogram construct 400. In one example, the radial histogram construct 400 may be divided into a plurality of equally sized elements or sections. Each element may be a “slice” of the radial histogram construct 400. For example, if the radial histogram construct 400 were divided into six elements, each element may span 60 degrees of the radial histogram construct 400. To illustrate, the first element may be an area covering from 0 degrees to 60 degrees, the second element may be an area covering from 60 degrees to 120 degrees, and so forth, around the radial histogram construct.

Each element may be a graphical representation of a value in the radial histogram 450. Using the example above, the radial histogram 450 may have each of the six elements of the radial histogram construct 400 along an x-axis 452 and a count of each pixel that is “on” within the area A that is processed along a y-axis 454.

To illustrate, the radial histogram construct 400 may be placed over the monochromatic image 302. The parameters of the radial histogram construct 400 may be set to have 6 elements, where each element is 60 degrees apart and that the area M covers the monochromatic image 302. A number of pixels that are “on” may be counted within each area A of each element around the radial histogram construct 400. The number of pixels that are “on” may be the value assigned to the first element. For example, the first element may cover a range of 0 degrees to 60 degrees and may be assigned a value of 20 in the radial histogram for the monochromatic image 302 based on 20 pixels that are identified as being “on” within the first element. The second element may cover a range of 60 degrees to 120 degrees and may be assigned a value of 50 based on 50 pixels that are identified as being “on” within the second element, and so forth for each element of the radial histogram construct 400.

The radial histogram construct 400 may be placed over the monochromatic image 304 and the monochromatic image 306 and the above process may be repeated to create the radial histogram for the monochromatic image 304 to create the radial histogram for the monochromatic image 306. It should be noted that each pixel located within the area A that is “on” (e.g., has a value that meets the respective threshold used to create the monochromatic image 302, 304 or 306) is counted in only one of the elements of the respective radial histogram.

In addition, a plurality of rotated radial histograms may be created in some implementations. The rotated radial histograms may comprise elements that contain shifted values of the elements of the respective radial histogram. The radial histograms that are generated for the monochromatic images 302, 304 and 306 may be stored in the DB 108 and used for identifying the image, as described below. In some implementations, the rotated radial histograms may also be compressed into the consolidated set of N bytes 330. Using the example described in FIG. 3, three layers 350, 352, and 354 are compressed into three different columns of bit values 316, 318 and 320 at the single bit offsets 310, 312 and 314, respectively. The five remaining single bit offsets may be used to store columns of bit values of five rotated radial histograms.

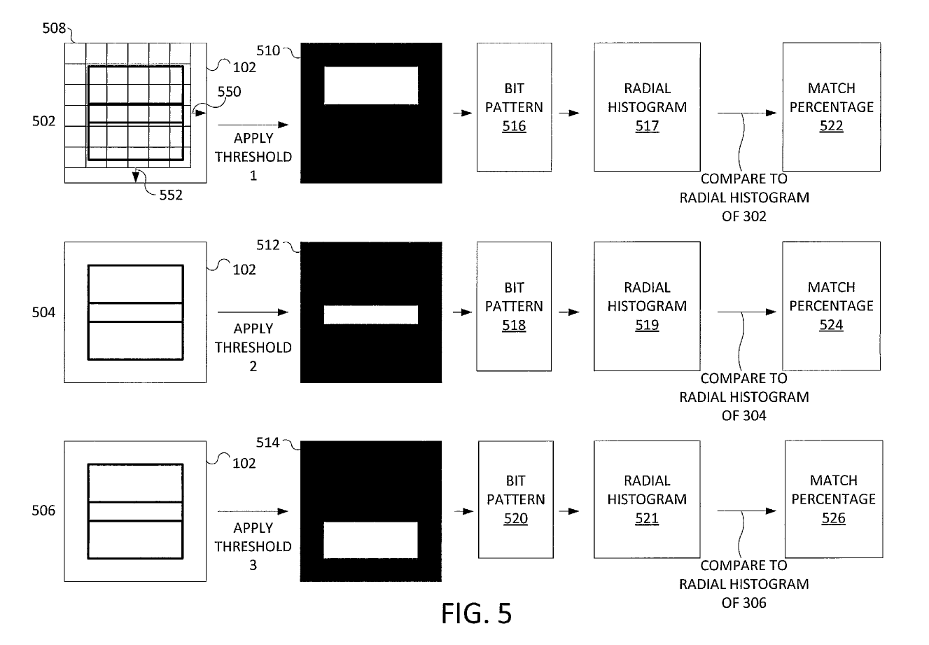

Referring back to FIG. 2, the identification engine 206 may identify an image as being the known image based on an analysis of the image. FIG. 5 illustrates an example diagram of performing multilayer pattern matching analysis to identify the image 102. The image 102 may be a two-dimensional array of pixels, each pixel being represented by a byte (although other sized data units may be used). For example, the image 102 may be a two-dimensional array of 128 bytes by 128 bytes.

In one example, the identification engine 206 may analyze each byte within a two dimensional byte array window 508 applied to the image 102. For example, if the image 102 is larger than the window 508, the window 508 may be moved one byte at a time from left to right as shown by arrow 550 and one byte at a time from top to bottom as shown by arrow 552 each time the analysis is repeated. For example, the dimensions of the window 508 may be 64 bytes by 64 bytes and the dimension of the image 102 may be 128 bytes by 128 bytes. Since the dimensions of the image 102 are larger than the dimensions of the window 508, the window 508 may be moved one byte at a time to analyze the entire image 102.

In one implementation, the image 102 may be converted into monochromatic images 510, 512 and 514. For example, the threshold 1 applied to the known image 300, as described above, may be applied to image 102 to generate a monochromatic image 510. The threshold 2 applied to the known image 300, as described above, may be applied to the image 102 to generate a monochromatic image 512. The threshold 3 applied to the known image 300, as described above, may be applied to the image 102 to generate a monochromatic image 514.

A respective threshold associated with a layer of the plurality of layers of the known image 300 may be applied to the image 102 to convert the image 102 into a respective monochromatic image 510, 512 and 514. In one implementation, the threshold 1, the threshold 2 and the threshold 3 may be applied at the same time, or substantially the same time, to the image 102 to generate the monochromatic images 510, 512 and 514, as shown by parallel processes 502, 504 and 506. In other words, the processor (e.g., the GPU) may perform the processes 502, 504 and 506 in parallel, or simultaneously, on each byte of the image 102 within the window 508.

For example, in the process 502 the threshold 1 may be applied to the image 102 to search for the features of the layer 350 (e.g., a blue rectangle at the top of the image) of the known image 300. Similarly, in the processes 504 and 506, the threshold 2 may be applied to the image 102 to search for the features of the layer 352 of the known image 300 and the threshold 3 may be applied to the image 102 to search for the layer 354 of the known image 300.

The monochromatic images 510, 512 and 514 may be associated with a respective bit pattern. In some implementations, a bit pattern may be represented by a bit value of a plurality of bytes that represent the corresponding monochromatic image. The bit pattern may be a plurality of 1 bit values representing the corresponding monochromatic image. For example, the monochromatic image 510 may be associated with a bit pattern 516, the monochromatic image 512 may be associated with a bit pattern 518 and the monochromatic image 514 may be associated with a bit pattern 520.

In one example, the radial histogram construct 400 may be applied (e.g., by the radial histogram engine 204) to the monochromatic image 510, the monochromatic image 512 and the monochromatic image 514 to generate a radial histogram 517, a radial histogram 519 and a radial histogram 521, respectively. Radial histograms 517, 519 and 521 may be generated (e.g., by the radial histogram engine 204) using the radial histogram construct 400 and the process described above with respect to the radial histograms generated for the monochromatic images 302, 304, and 306. Then, the pre-generated radial histograms of the known image 300, and each of the rotated radial histograms, that were generated by the radial histogram engine 204 may be compared to the radial histograms 517, 519 and 521. For example, the radial histogram of the known monochromatic image 302, and each of the associated rotated radial histograms, may be compared to the radial histogram 517 of the monochromatic image 510 in process 502.

In one example, the radial histograms 517, 519 and 521 may be scaled to provide an accurate identification. To illustrate, for the pre-generated radial histogram of the known monochromatic image 302, a maximum value of an element may be determined, a minimum value of the element may be determined, and a range of values of the element of the radial histogram may be determined as the difference between the maximum value and the minimum value. For example, for the first element of the radial histograms of the known monochromatic image 302 the values of the first element may range from 25 to 17. Thus, the range of values for first element of the radial histogram may be 8 (e.g., 25-17). This may be repeated for each element (e.g., each bin along the x-axis of the radial histogram) of the radial histogram.

If the scaling of the radial histograms of the monochromatic image 510 is not the same, or similar, as the scaling of the pre-generated radial histograms of the known monochromatic image 302, the value of each element of the radial histogram 517 may fall outside of the range of each element of the radial histograms of the known monochromatic image 302. For example, the range of the first element of the pre-generated radial histograms of the known monochromatic image 302 may be 8 and the value of the first element of the radial histogram 517 may be 10. However, the value of each element of the radial histogram 517 may fall outside of the range of each element of the pre-generated radial histogram of the known monochromatic image 302 by a same scalar value. For example, each value of each element of the radial histogram 517 falls outside of the range by a scalar value of 2. The radial histograms may be scaled to each other based on the scalar value. Based on the comparison, it may be determined which of the pre-generated radial histograms of the known monochromatic image 302 (e.g., including the rotated radial histograms) most closely matches the radial histogram 517 of the monochromatic image 510.

Similar to process 502, in process 504, the pre-generated radial histogram associated with the known monochromatic image 304 may be compared to the radial histogram 519 of the monochromatic image 512. In process 506, the pre-generated radial histogram of the known monochromatic image 306 may be compared to the radial histogram 521 of the monochromatic image 514.

In one implementation, the comparison may be performed based on an origin of the radial histograms. For example, the radial histogram 517 may be aligned such that the comparison of the radial histogram 517 begins at a same origin on the image 102 as the pre-generated radial histogram that was generated from the known monochromatic image 302. Otherwise, if the origins are not aligned, then the radial histograms may be offset. For example, the first element of the radial histogram 517 may have a value of 20, the second element of the radial histogram 517 may have a value of 15 and the third element of the radial histogram 517 may have a value of 27. The value of the first element, the second element and the third element of the pre-generated radial histogram of the known monochromatic image 302 may also be 20, 15 and 27, respectively. However, due to misalignment of the origins, the second element of the pre-generated radial histogram of the known monochromatic image 302 may have a value 20, the third element may have a value of 15 and the fourth element may have a value of 27. Thus, due to the offset in values of the elements caused by the misalignment of the origins, the identification engine 206 may misidentify the image 102 as a match of the known image 300. However, aligning the origin of the radial histograms prevents the misidentification from occurring.

A match percentage may be tracked for each process 502, 504 and 506. In some implementations, the match percentage may be based on a percentage of the elements that match. In one example, the value of each element of the radial histograms may be compared. For example, the value of the first element of the radial histogram 517 may be compared to the value of the first element of the pre-generated radial histogram of the known monochromatic image 302. The value of the second element of the radial histogram 517 may be compared to the second element of the pre-generated radial histogram of the known monochromatic image 302, and so forth. The match percentage may be calculated by dividing the total number of matching elements divided by the total number of elements.

The match percentage of each process 502, 504 and 506 is compared to a match threshold (e.g., 90% or greater). In some implementations, the match percentage may be different at different times or may be different for each process 502, 504 and 506. If the match percentage of each process 502, 504 and 506 is determined to be above the match threshold, then the image 102 is identified as matching the known image 300.

Notably, if the image 102 was not the same as the known image 300, when the thresholds 1, 2, and 3 are applied to the image 102 to generate the monochromatic images 510, 512 and 514, respectively, the monochromatic images 510, 512 and 514 would look different than the known monochromatic images 302, 304 and 306 generated from the known image 300 using the same thresholds 1, 2, and 3. As a result, the match percentage of the radial histograms 517, 519 and 521 to the pre-generated radial histograms of the known monochromatic images 302, 304 and 306, respectively, would likely fall below the match threshold and the image 102 would not be identified as being the known image 300.

As noted above, each one of the processes 502, 504 and 506 may be executed in parallel, or simultaneously, by the processor. In other words, by compressing the plurality of layers of the known image 300 into columns of bit values at different bit offsets of a consolidated set of N bytes, as discussed above, a single byte array of the image 102 may be analyzed to detect and match bit patterns of a plurality of different radial histograms simultaneously.

It should be noted that it is assumed that the exposure or saturation of the image 102 is similar to the exposure or saturation of the known image 300. For example, color values in an image are a representation of interpreted spectrum or a range of spectrums of light. Such channel could contain values that are not related to visible light. Such data channels could be associated with predefined data placed into data channels that is not associated with any light, but actually a pre-generated monochromatic image to utilize the matching and layer technology. If the exposure or the saturation level is not the same between the image 102 and the known image 300, the image 102 may be preprocessed such that the exposure or the saturation of the image 102 is similar to the known image 300.

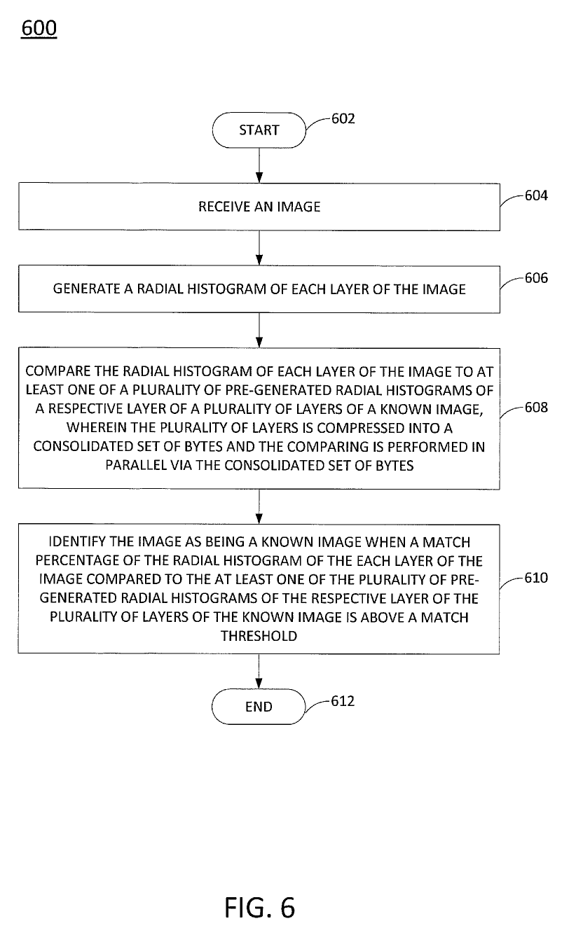

FIG. 6 illustrates a flow diagram of an example method 600 for identifying an image as a known image. The method 600 may be performed by the server 106.

At block 602, the method 600 begins. At block 604, the method 600 receives an image. For example, a camera may capture the image so that the image can be identified. The image may be, for example, a logo.

At block 606, the method 600 generates a radial histogram of each layer of the image. For example, a monochromatic image for each layer of the image that is captured may be created using a respective threshold associated with a layer of a plurality of layers of the known image to convert the image into a respective monochromatic image. For example, a process to generate the radial histogram is described above with reference to FIG. 5.

In one example, the radial histogram for each layer of the image may be generated by analyzing each byte of the image within a two-dimensional byte array window. The two-dimensional byte array window may be moved one byte at a time until all bytes of the image are analyzed. The analysis of each byte of the image may be used to generate the monochromatic images via a thresholding process that is applied to the image, as described above. The radial histogram construct 400 may be applied to the monochromatic images to generate the radial histograms, as described above.

At block 608, the method 600 compares the radial histogram of each layer of the image to at least one of a plurality of pre-generated radial histograms of a respective layer of a plurality of layers of a known image, wherein the plurality of layers is compressed into a consolidated set of bytes and the comparing is performed in parallel via the consolidated set of bytes. As discussed above with reference to FIG. 3, a radial histogram of each layer of the known image may be pre-generated. In addition, each layer of the known image may be compressed into a consolidated set of bytes to allow each layer to be processed in parallel (e.g., by a graphical processing unit (GPU)). For example, the consolidated set of bytes may include a plurality of columns of bit values. Each column of the plurality of columns may be associated with a respective single bit offset of a plurality of single bit offsets of the consolidated set of bytes. Each one of the plurality of columns associated with a respective single bit offset of the consolidated set of bytes may contain the bit values that represent the respective layer that is used to generate a respective one of the plurality of pre-generated radial histograms.

In one example, the pre-generated radial histogram of the plurality of pre-generated radial histograms that is selected to be compared to the radial histogram of a layer of the image may be based on the threshold value that was used to create radial histogram of the layer. For example, a first threshold may be applied to the image to create a monochromatic image that is used to create the radial histogram. The pre-generated radial histogram generated based on a known monochromatic image that was created using the first threshold may then be selected to be compared to the radial histogram of the image created by applying the threshold 1. The comparison may be performed based on an origin of a bit pattern of the pre-generated radial histogram of each layer of the know image.

In other words, the pre-generated radial histograms may represent known bit patterns of the known monochromatic images of the known image. The pre-generated radial histograms may represent a pattern that is being searched for with the image that is captured. The radial histogram of each layer of the image may be considered as the input that is being compared to the pre-generated radial histograms to try and identify the image. The compression of the plurality of layers into the consolidated set of bytes allows multiple comparisons between the radial histogram of each layer of the image and the pre-generated radial histograms to occur in parallel. This is more efficient than performing the comparison serially (e.g., one at a time) when the radial histogram of each layer is processed in color that uses the full 8 bits of each byte.

At block 610, the method 600 identifies the image as being a known image when a match percentage of the radial histogram of the each layer of the image compared to the at least one of the plurality of pre-generated radial histograms of the respective layer of the plurality of layers of the known image is above a match threshold. For example, the match threshold may be 95%. The match percentage between the comparison of the radial histogram of the bit pattern that represents the known monochromatic image 302 and the radial histogram of the bit pattern of the monochromatic image created by applying the threshold 1 to the captured image may be 97%. The match percentage between the comparison of the radial histogram of the bit pattern that represents the known monochromatic image 304 and the radial histogram of the bit pattern of the monochromatic image created by applying the threshold 2 to the captured image may be 99%. The match percentage between the comparison of the radial histogram of the bit pattern that represents the known monochromatic image 306 and the radial histogram of the bit pattern of the monochromatic image created by applying the threshold 3 to the captured image may be 98%. Since all three match percentages are above the match threshold of 95%, then the captured image may be identified as being the known image.

In some implementations, as noted above, the origins of each layer may be different. As a result, the determination of whether a comparison between radial histograms is above a match threshold may occur at different times. The match percentages may be calculated at different times and coordinated to determine whether all the comparisons are above the match threshold.

In contrast, if any one of the match percentages were below the match threshold of 95%, then the captured image may not be identified as being the known image. In other words, the captured image is different than the known image.

As a result, the method 600 allows for multi-pattern or multi-layer matching simultaneously on the same byte and over an array of different bytes that are being analyzed within the two-dimensional byte array window. At block 612, the method 600 ends.

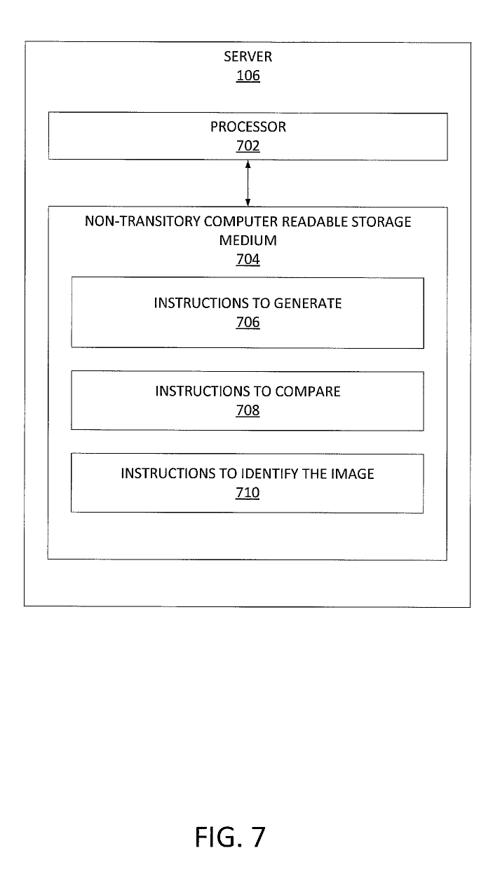

FIG. 7 illustrates another example block diagram of the server 106. The server 106 may comprise a processor (e.g., a GPU or a CPU) 702 and a non-transitory computer-readable storage medium 704. The non-transitory computer-readable storage medium 704 may include instructions 706, 708 and 710 that can be executed by the processor 702.

In one example, the instructions 706 may include instructions to generate. For example, a plurality of radial histograms may be generated, wherein each one of the plurality of radial histograms is associated with a respective layer of a plurality of layers of a known image, wherein the plurality of layers is compressed into a consolidated set of bytes, wherein the consolidated set of bytes comprises a plurality of columns of bit values, wherein each column of the plurality of columns is associated with a respective single bit offset of a plurality of single bit offsets of the consolidated set of bytes, wherein each one of the plurality of columns associated with the respective single bit offset of the consolidated set of bytes contains the bit values that represent the respective layer that is used to generate a respective one of the plurality of radial histograms. The instructions 708 may include instructions to compare. For example, at least one of the plurality of radial histograms of the known image may be compared to a subsequently generated radial histogram of each layer of a received image in parallel via the consolidated set of bytes. The instructions 710 may include instructions to identify the image. For example, the image may be identified as a match of the known image when a match percentage of the subsequently generated radial histogram of the each layer of the image compared to the pre-generated radial histogram of the each layer of the received image compared to the at least one of the plurality of radial histograms of the know image is above a match threshold.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
receiving, using a processor, an image;
generating, using the processor, a radial histogram of each layer of the image;
comparing, using the processor, the radial histogram of the each layer of the image to at least one of a plurality of pre-generated radial histograms of a respective layer of a plurality of layers of a known image, wherein the plurality of layers is compressed into a consolidated set of bytes and the comparing is performed in parallel via the consolidated set of bytes; and
identifying, using the processor, the image as a match of the known image when a match percentage of the radial histogram of the each layer of the image compared to the at least one of the plurality of pre-generated radial histograms of the respective layer of the plurality of layers of the known image is above a match threshold.

2. The method of claim 1, wherein the plurality of pre-generated radial histograms is generated based upon a bit pattern of a known monochromatic image of the respective layer of the plurality of layers of the known image.

3. The method of claim 1, wherein the radial histogram of the each layer of the image is generated based upon a bit pattern of a monochromatic image of the each layer of the image.

4. The method of claim 3, wherein the monochromatic image of the each layer of the image is generated using a respective threshold used to create a known monochromatic image of the respective layer of the plurality of layers of the known image.

5. The method of claim 1, wherein the each layer of the known image comprises a unique feature of the known image.

6. The method of claim 1, wherein the generating the radial histogram of the each layer of the image comprises:
analyzing, using the processor, each byte of a plurality of bytes of the image within a two-dimensional byte array window; and
moving, using the processor, the two-dimensional byte array window one byte at a time until all bytes of the image are analyzed.

7. The method of claim 1, wherein the comparing is based on an origin of a bit pattern of the pre-generated radial histogram of the each layer of the known image.

8. A non-transitory computer-readable storage medium encoded with instructions executable by a processor, the computer-readable storage medium comprising:
instructions to generate a plurality of radial histograms, wherein each one of the plurality of radial histograms is associated with a respective layer of a plurality of layers of a known image, wherein the plurality of layers is compressed into a consolidated set of bytes;
instructions to compare at least one of the plurality of radial histogram of the known image to a subsequently generated radial histogram of each layer of a received image in parallel via the consolidated set of bytes; and
instructions to identify the received image as a match of the known image when a match percentage of the subsequently generated radial histogram of the each layer of the received image compared to the at least one of the plurality of radial histograms of the known image is above a match threshold.

9. The non-transitory computer-readable storage medium of claim 8, wherein the plurality of radial histograms is generated based upon a bit pattern of a known monochromatic image of the respective layer of a plurality of layers of the known image.

10. The non-transitory computer-readable storage medium of claim 8, wherein the subsequently generated radial histogram of the each layer of the received image is generated based upon a bit pattern of a monochromatic image of the each layer of the received image.

11. The non-transitory computer-readable storage medium of claim 10, wherein the monochromatic image of the each layer of the received image is generated using a respective threshold used to create a known monochromatic image of the each layer of the known image.

12. The non-transitory computer-readable storage medium of claim 8, wherein the each layer of the known image comprises a unique feature of the known image.

13. The non-transitory computer-readable storage medium of claim 8, wherein the instructions to generate the radial histogram of the each layer of the image comprises:
instructions to analyze each byte of a plurality of bytes of the received image within a two-dimensional byte array window; and
instructions to move the two-dimensional byte array window one byte at a time until all bytes of the received image are analyzed.

14. An apparatus, comprising:
a compression engine to compress each layer of a plurality of layers of a known image into a consolidated set of bytes;
a radial histogram engine to create a plurality of pre-generated radial histograms, wherein each one of the plurality of pre-generated radial histograms is associated with a different one of the plurality of layers of the known image and to create a radial histogram for each layer of an image that is captured; and
an identification engine to identify the image as a match of the known image based on a match percentage being above a match threshold, wherein the match percentage is based on a comparison of the radial histogram of the each layer of the image to at least one of the plurality of pre-generated radial histograms of the each layer of the known image in parallel via the consolidated set of bytes.

15. The apparatus of claim 14, wherein the consolidated set of bytes comprises a plurality of columns of bit values, wherein each column of the plurality of columns is associated with a respective single bit offset of a plurality of single bit offset of the consolidated set of bytes, wherein each one of the plurality of columns associated with the respective single bit offset of the consolidated set of bytes contains the bit values that represent a respective layer that is used to generate a respective one of the plurality of pre-generated radial histograms.
